(19) United States
(12) Patent Application Publication
(10) Pub. No.: US 2025/0291900 A1
(43) Pub. Date: Sep. 18, 2025

(54) SYSTEMS AND METHODS FOR ANOMALY DETECTION IN NETWORK DEVICES

(71) Applicant: JPMORGAN CHASE BANK, N.A., New York, NY (US)

(72) Inventors: Mohammed AYUB, Jersey City, NJ (US); William Joel GUEST, Conroe, TX (US); Sean MORAN, London (GB); Bruce PEIKON, East Northport, NY (US)

(21) Appl. No.: 19/072,371

(22) Filed: Mar. 6, 2025

Related U.S. Application Data
(60) Provisional application No. 63/565,290, filed on Mar. 14, 2024.

(51) Int. Cl. G06F 21/55

(52) U.S. Cl. CPC G06F 21/552; G06F 2221/034

(57) ABSTRACT

Systems and methods for anomaly detection in network devices are disclosed. A method may include: receiving a plurality of log messages from a data source; creating an offline anomaly detection model by: performing statistical modelling on the log messages from each network device; creating a log template for each log message based on static and variables parts of the log message; creating a template dictionary of log templates for each network device; creating a log template distribution; and creating template variables; receiving streaming data comprising log files from a plurality of network devices; aggregating the streaming data for each network device for a period of time; identifying an anomaly in the aggregated streaming data using the offline anomaly detection model; classifying the anomaly as a rate anomaly, a time anomaly, or a variable anomaly; and executing a self-healing action based on the classification.

### RELATED APPLICATIONS

This application claims priority to, and the benefit of, U.S. Provisional Patent Application Ser. No. 63/565,290, filed Mar. 14, 2024, the disclosure of which is hereby incorporated, by reference, in its entirety.

### BACKGROUND OF THE INVENTION

### 1. Field of the Invention

Embodiments relate to systems and methods for anomaly detection in network devices.

### 2. Description of the Related Art

System logs, generated by software applications, operating systems, and network devices, provide a record of system activities and form a critical source of information for the enterprise facilitating a host of data mining activities, from the detection of anomalous events to a myriad of other applications, including security and vulnerability diagnosis and understanding system errors and crashes. Log-based anomaly detection plays a crucial role in ensuring the integrity and security of information technology (IT) systems by identifying abnormal patterns in log data. Anomalies in log data can manifest as deviations from normal behavior, indicating potential security threats, system malfunctions, or fraudulent activities. As organizations increasingly rely on complex computing environments, there is a constant need to evolve anomaly detection technology to meet the growing challenges inherent in effectively detecting anomalies over large-scale datasets for mission critical industrial applications.

### SUMMARY OF THE INVENTION

Systems and methods for anomaly detection in network devices are disclosed. According to one embodiment, a method may include: (1) receiving, by an anomaly detection computer program, a plurality of log messages from a data source; (2) creating, by the anomaly detection computer program, an offline anomaly detection model by: (a) performing statistical modelling on the log messages from each network device; (b) creating a log template for each log message based on static and variables parts of the log message; (c) creating a template dictionary of log templates for each network device; (d) creating a log template distribution; and (e) creating template variables; (3) receiving, by the anomaly detection computer program, streaming data comprising log files from a plurality of network devices; (4) aggregating, by the anomaly detection computer program, the streaming data for each network device for a period of time; (5) identifying, by the anomaly detection computer program, an anomaly in the aggregated streaming data using the offline anomaly detection model; (6) classifying, by the anomaly detection computer program, the anomaly as a rate anomaly, a time anomaly, or a variable anomaly; and (7) executing, by the anomaly detection computer program, a self-healing action based on the classification.

In one embodiment, each log message comprises a date time of the log, a network device name or identifier, an error code, and an error description.

In one embodiment, the method may also include: preprocessing, by the anomaly detection computer program, the log messages; and encoding, by the anomaly detection computer program, the preprocessed log messages.

In one embodiment, the preprocessing comprises transforming the log messages.

In one embodiment, the statistical modelling comprises a rate and a distribution of each log message.

In one embodiment, the log template distribution is based on statistical rates and probabilities of the log templates for a period of time.

In one embodiment, the template variables comprise special identifiers for dynamic parts of the log messages.

In one embodiment, the method may also include: calculating, by the anomaly detection computer program, a uniqueness of each variable position for each template variable in each log template.

In one embodiment, the rate anomaly is identified based on a rate of logs files in the aggregated streaming data for one of the log templates.

In one embodiment, the time anomaly is identified based on an average time between log files in the aggregated streaming data.

In one embodiment, the self-healing action comprises disabling outside network connections.

In one embodiment, the self-healing action comprises deploying additional hardware.

In one embodiment, the self-healing action comprises disabling a workflow.

According to another embodiment, a non-transitory computer readable storage medium may include instructions stored thereon, which when read and executed by one or more computer processors, cause the one or more computer processors to perform steps comprising: receiving a plurality of log messages from a data source; creating an offline anomaly detection model by: performing statistical modelling on the log messages from each network device, wherein the statistical modelling comprises a rate and a distribution of each log message; creating a log template for each log message based on static and variables parts of the log message; creating a template dictionary of log templates for each network device; creating a log template distribution, wherein the log template distribution is based on statistical rates and probabilities of the log templates for a period of time; and creating template variables, wherein the template variables comprise special identifiers for dynamic parts of the log messages; receiving streaming data comprising log files from a plurality of network devices; aggregating the streaming data for each network device for a period of time; identifying an anomaly in the aggregated streaming data using the offline anomaly detection model; classifying the anomaly as a rate anomaly, a time anomaly, or a variable anomaly; and executing a self-healing action based on the classification.

In one embodiment, each log message comprises a date time of the log, a network device name or identifier, an error code, and an error description.

In one embodiment, the non-transitory computer readable storage medium may also include instructions stored thereon, which when read and executed by one or more computer processors, cause the one or more computer processors to perform steps comprising: transforming the log messages; and encoding the transformed log messages.

In one embodiment, the non-transitory computer readable storage medium may also include instructions stored thereon, which when read and executed by one or more computer processors, cause the one or more computer processors to perform steps comprising: calculating a uniqueness of each variable position for each template variable in each log template.

In one embodiment, the rate anomaly is identified based on a rate of logs files in the aggregated streaming data for one of the log templates and the time anomaly is identified based on an average time between log files in the aggregated streaming data.

In one embodiment, the self-healing action comprises disabling outside network connections, deploying additional hardware, and/or disabling a workflow.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for anomaly detection in network devices according to an embodiment.

FIG. 2 depicts a method for training of an offline anomaly detection model in network devices according to an embodiment.

FIG. 3 depicts a method for online inference processing using an offline anomaly detection model according to an embodiment.

FIG. 4 depicts an exemplary computing system for implementing aspects of the present disclosure.

### DETAILED DESCRIPTION OF PREFERRED EMBODIMENTS

Systems and methods for anomaly detection in network devices are disclosed.

Embodiments may provide (1) a simple, efficient and unsupervised modeling methodology to handle huge unlabeled datasets of log messages; (2) a scalable deployment pipeline that can extend to similar network devices that have similar log structures; (3) optimized control to change thresholds for alerting (reduces alert fatigue); and (4) explain-ability, to classify and provide simple and efficient statistical explanations on why the anomaly was detected to assist in troubleshooting issues.

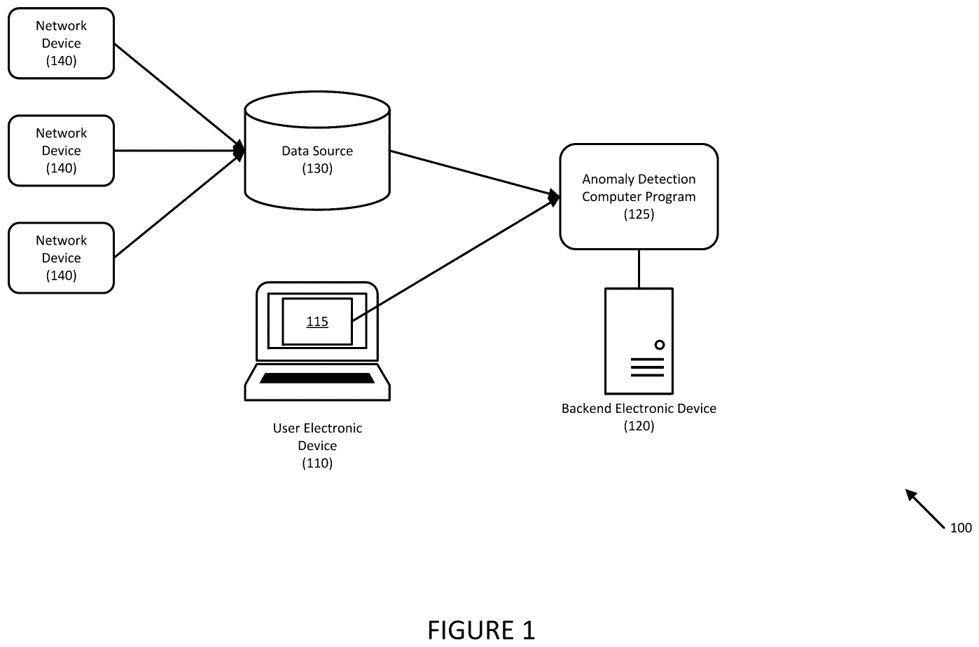

Referring to FIG. 1, a system for offline anomaly detection in network devices is provided according to an embodiment. System 100 may include user electronic device 110, which may be a computer (e.g., a workstation, a desktop, a laptop, a notebook, a tablet, etc.), a smart device (e.g., smart phone, smart watch, etc.), an Internet of Things (IoT) appliance, etc. User electronic device 110 may execute user computer program 115.

System 100 may further include backend electronic device 120, such as a server (e.g., physical and/or cloud-based), a computer, etc. Backend electronic device 120 may execute anomaly detection computer program 125. Anomaly detection computer program may train an offline model to detect anomalies in data from data source 130.

Data source 130 may receive and store data, such as log messages, from network devices 140 in a computer network. Examples of network devices 140 may include switches, routers, network interface devices, applications, embedded systems, virtualized hardware, etc.

During the training phase, data source 130 may provide stored data from network devices 140 to anomaly detection computer program 125 for training.

During the inference phase, data source 130 may collect live streaming data from network devices 140 and may stream the data to anomaly detection computer program 125.

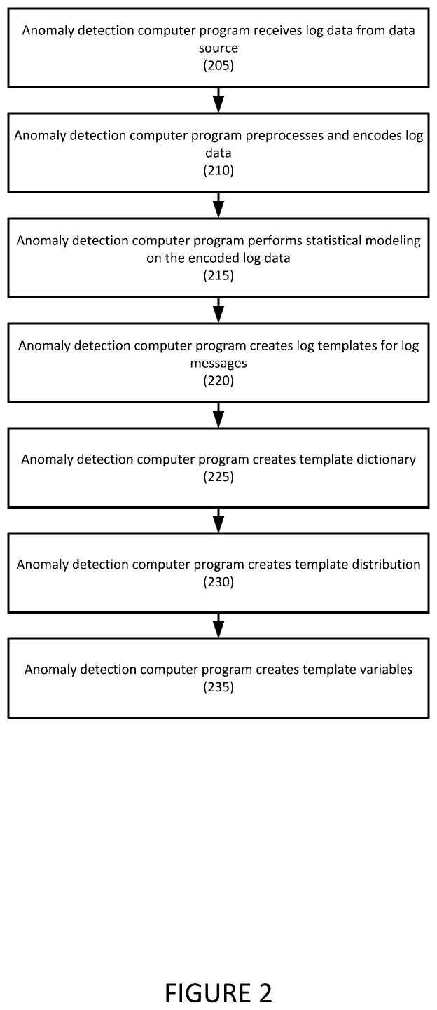

Referring to FIG. 2, a method for training of an offline anomaly detection model in network devices is provided according to an embodiment. In one embodiment, the training may be performed on a large set of data to learn representation/patterns usually on a limited data range like the past one year etc.

In step 205, an anomaly detection computer program may receive log messages from a data source. For example, the log messages may include data time of the log, network device name or identifier, error code, and error description(s). An example of a log message (with the date time and device name removed is “sys log 1233: Syslog connection established; i\′.Lno=‘789’, server=‘123.45.67.89:1234’, local=‘123.45.67.89:0123’”.

In step 210, the anomaly detection computer program may preprocess and encode the log messages by applying various transformations such as format conversions, message splitting, filters to remove noise, etc.

In step 215, the anomaly detection computer program may perform statistical modeling on the encoded log messages. In one embodiment, this may be achieved by iteratively performing steps 220, 225, 230, and 235 on each log message. In one embodiment, the anomaly detection computer program may store the rate and distribution of each log message from each network device to capture local device-based characteristics.

In step 220, the anomaly detection computer program may generate a log template for each log message. Log templates may be created by capturing static and variable parts of the log messages. An example of such a process may use a Python library called DRAIN3 which identifies patterns within log messages and replaces variables within the pattern with identifiers. A log template becomes anomalous when it starts to appear above or falls below a certain threshold (e.g., more than two standard deviations away from its mean value). The threshold may be configurable as is necessary and/or desired.

In step 225, the anomaly detection computer program may create a template dictionary of log templates. A template dictionary is a collection of log templates for a particular network device. The creation of the template dictionary facilitates the correlation of unique log templates with corresponding devices observed. The granularity of uniqueness can be tailored to specific network devices such as devices, components, or applications, aligning with the contextual relevance of the analysis.

An illustrative template dictionary is provided below:

| Tem- | | | | |
|---|---|---|---|---|
| plate | | | | Device Log |
| ID | Log Message | Device | Log template | template |
| 1 | conn error | Dev1 | conn error | conn error |
| | found at | | found | found |
| | 0x2344 | | at <*> | at <*>_dev1 |
| 2 | proc1234 | Dev1 | <*>success- | <*>successfully |
| | successfully | | fully | completed_dev1 |
| | completed | | completed | |
| 3 | mgmt 2312 | Dev2 | mgmt | mgmt <*>folder |
| | folder | | <*>folder | created <*>_dev2 |
| | created | | created <*> | |
| | name=/usr/id | | | |

The device name or identifier may be appended to the log template and also add an identifier (e.g., Template ID) for each template dictionary.

In step 230, the anomaly detection computer program may create a log template distribution. In one embodiment, the log template distribution may be based on statistical rates and probabilities of the log templates. For a given training period and every unique log template, a comprehensive set of hourly statistics is captured. These encompass capturing a list of log template timestamps (time), rate, daily occurrence probability (day-indicating the frequency of log template occurrences over the entire training window period), as well as the mean and standard deviation of log template timestamps.

To ensure a normalized and standardized representation, both the rate and day may be adjusted relative to the number of training days used by the model.

The mapping in the template dictionary may be used against every log message to aggregate the log templates per device and per hour in a day. The raw aggregation gives a rate; the log template distribution may be calculated by converting the hours to seconds and taking an arithmetic mean of the values per device and per hour.

In step 235, the anomaly detection computer program may create template variables. Template variables are dynamic parts of log messages that are replaced by special identifiers. Example of such include identifiers, URL's, filenames, etc. that may change frequently within the log message. The template variables may capture semantic differences. Semantic changes within log templates may be discerned through a multifaceted approach. Firstly, the probability of observing the string at a particular variable position in the template may be calculated as a ratio of total occurrences of each string to total messages seen in that template given by the following equation for template i and variable position j:

$$pos\_prob {\_string}_{ijk} = \frac{{frequency\_string}_{ijk}}{total\_template {\_messages}_{i}}$$

Consequently, variable positions with commonly occurring strings exhibit higher ratios, while those with rare strings showcase comparatively lower values.

Next, the uniqueness of each variable position in the log template, var_pos_uniqueᵢⱼ, may be computed. This is quantified as a ratio of unique strings seen at a particular position to the total log messages within the template group for log template i and variable position j:

$$var\_pos {\_unique}_{ij} = \frac{count\_unique {\_string}_{ij}}{total\_template {\_messages}_{i}}$$

The higher the uniqueness value of the variable position, the greater the number of unique strings are seen at that position.

In one embodiment, a cache may be created to house anomalous variables identified through the positional statistics. This cache significantly accelerates the detection of string anomalies. Each template i can contain multiple variable positions, and each variable position j can contain multiple strings. The notation, stringᵢⱼₖ represents a single string k within the list of strings at a variable position j within a template i.

Anomalous stringᵢⱼₖ may be identified as follows:

$$cache\_anomalous = \{ \begin{matrix}L & if {prob\_sum}_{ij} < λ \\ null & otherwise\end{matrix}$$

where L is a list of anomalous strings, prob_sumᵢⱼ is ∀ᵢⱼpos_prob_stringᵢⱼₖ<θ, and λ is the probability threshold.

Here, pos_prob_stringᵢⱼₖ is a ratio of total occurrences of each string to total log messages seen in that template. var_pos_uniqueᵢⱼ is the uniqueness of the variable position j within template i. cache-anomalous is a list of strings denoted by L. prob_sumᵢⱼ is the total sum of the probabilities of the string ijk at a given variable position j within a template i.

The output of this equation, cache_anomalous, can either be a list of anomalous stringᵢⱼₖ, denoted as L, or null, depending on the conditions met. The variable L represents a list of anomalous stringᵢⱼₖ. If the condition prob_sumᵢⱼ<λ is met, all stringᵢⱼₖ with a probability, pos_prob_stringᵢⱼₖ less than θ are considered anomalous and added to L. This list encapsulates the stringᵢⱼₖ deemed significantly anomalous within the context of their specific variable position j within a template i.

The variable prob_sumᵢⱼ is the total sum of the probabilities of the stringᵢⱼₖ at a given variable position j within a template i that have a probability pos_prob_stringᵢⱼₖ less than θ. θ is a configurable, very small value of stringᵢⱼₖ probability (e.g., 0.02), serving as a threshold to identify stringᵢⱼₖ with a very low probability of occurrence.

If the total sum of these probabilities is less than λ, the stringᵢⱼₖ are deemed anomalous. The variable λ in cache_anomalous is a probability threshold set as 0.5. This value serves as a threshold to prevent the identification of all unique stringᵢⱼₖ as anomalous. This is particularly important in cases where a variable position j within a template i has a high degree of uniqueness.

Additionally, a historical record of all variable combinations observed at each position may be stored. This historical dataset offers invaluable insights into the positions where variable anomalies were identified, enhancing our understanding of the evolving log template dynamics. An example of such cache structure is shown below:

| Tem- | Variable | Variable | Variable | Variable |
|---|---|---|---|---|
| plate_id | position 1 | position 3 | position 3 | position 4 |
| 4 | [ ] | [‘23’] | [ ] | [‘123.345.567.89:1234’] |

While this historical cache impacts the storage size of the model, it may be capped at a reasonable threshold to balance performance and accuracy considerations.

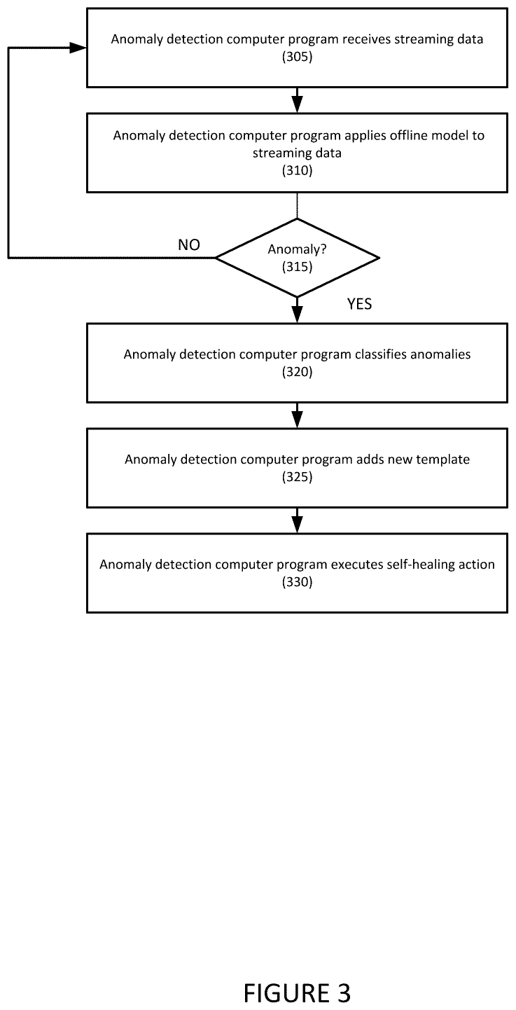

Referring to FIG. 3, a method for online inference processing using an offline anomaly detection model is disclosed according to an embodiment. For example, at inference time, a test window may be selected, and the current data may be compared to the offline anomaly detection model to identify an anomaly. If there is an anomaly, the root cause of the anomaly may be identified, and an action may be automatically taken.

In step 305, the anomaly detection computer program may receive streaming data. In one embodiment, the streaming data may be received from network devices in the form of log files (txt, csv or otherwise) via a data source.

In step 310, the anomaly detection computer program may apply the offline anomaly detection model to the log messages in the streaming data. The components of the offline model are listed below:

| | | | Anomaly Type |
|---|---|---|---|
| Object | Datatype | Description | Usage |
| Template | Dictionary | Dictionary mapping of every | Used as |
| Dictionary | | Device Template (seen during | reference |
| | | training) to an ID | mapping |
| Template | Table | Stores Rate and time | For Rate |
| Hourly | | distribution of each log | and Time |
| Dictionary | | template per device per hour | |
| Template | Dictionary | Dictionary containing, for | Variable |
| Variable | | each device template, | Anomaly |
| Position | | occurrence probability of each | |
| Dictionary | | template variable position, | |
| | | including length of total | |
| | | messages seen. | |
| Template | Dictionary | Uniqueness ratio for each | Variable |
| Position | | template variable position (no | Anomaly |
| Unique | | of vars in each position/total | |
| Dictionary | | messages seen), including | |
| | | length of total messages seen. | |
| Template | Dictionary | Cache of known anomalous | Variable |
| Anomalous | | variables (Set of vars that | Anomaly |
| Variable | | have occurrence prob totaling | |
| Dictionary | | up to 0.5) for each template | |
| Template | Table | Reformatted version of | Variable |
| Variable | | ‘Template Variable Position | Anomaly |
| Length | | Dictionary’ in a table form, | |
| | | for each template a table of | |
| | | variables in each position and | |
| | | total length. | |

For example, during a configurable period (e.g., an hour), the anomaly detection computer program may receive and aggregate log messages, calculate the rates and probabilities, and compare them to the offline anomaly detection model rates and probabilities to measure deviations.

The same process (e.g., step 220) may be applied to streaming data so that it is in the same format of template that can be compared for anomaly detection.

The offline anomaly detection model may return a binary output, for example, 0 for not anomalous and 1 for anomalous, performed for each message template seen per hour. If the template distributions are greater than the threshold, they may be classified as anomalous; otherwise, they are not anomalous. In one embodiment, all log templates may be classified, but only anomalous ones are flagged for review.

In step 315, if there is an anomaly, in step 320, the anomaly detection computer program may classify that anomaly. For example, the anomaly may be classified into one of three types of anomalies-rate anomalies, time anomalies, and variable anomalies. The thresholds for each type of anomaly may be set by the user.

A rate anomaly may be identified by comparing the rate of logs in a specific time period (e.g., one hour) for a specific template to the average rate of logs for that same time period and template. If the rate of logs is significantly higher than the average rate, this may represent a rate anomaly. For example, the mean and standard deviation may be checked against the template dictionary.

A time anomaly may be identified by comparing the average time between logs in a specific time period (e.g., one hour) for a specific template to the mean time between logs for that same time period and template. If the average time between logs is significantly different from the mean time, this may represent a time anomaly.

In one embodiment, a factor of 0.5 may be used as a buffer or threshold value in the anomaly detection algorithm, providing a margin of error. Allowing for some variation in the time between logs without immediately flagging it as an anomaly, aids in reducing the likelihood of false positives in the anomaly detection process.

A variable anomaly may capture the semantic differences in the log templates during inference. The log variables may be modeled as float and string given by the following equations:

$$float\_anomaly = \{ \begin{matrix}1 & if \vert var\_mea \text{?} - {var\_mean}_{train} \vert < \\ & ( 3 \times s \text{?} {d\_dev}_{train} ) \\ 0 & otherwise\end{matrix}$$

$${string\_anomaly}_{ijk} = \{ \begin{matrix} & if {string}_{ijk} is a new message , \\ 1 & or ( \begin{matrix}var\_pos {\_unique}_{ij} < \text{?} \\ and {string}_{ijk} in cache\_anomalous , \\ and ( var\_pos {\_unique}_{ij} \text{?} \\ total\_values {\_variable}_{ij} ) < δ\end{matrix} ) \\ 0 & otherwise\end{matrix}$$

$$\text{?} \text{indicates text missing or illegible when filed}$$

where.
   γ: uniqueness threshold (e.g., 0.25)
   δ: threshold for the product of the uniqueness of the variable position and the total number of values for that variable

The output is either 1, indicating an anomaly, or 0, signifying no anomaly, contingent on the conditions satisfied. For stringᵢⱼₖ to be deemed anomalous several conditions must be satisfied simultaneously.

First, the uniqueness of the variable position j within a template i, denoted as var_pos_uniqueᵢⱼ, must be less than a uniqueness threshold γ, which is set to 0.25 in this instance. Second, stringᵢⱼₖ must be present in cache_anomalous or be a new string not previously encountered in the historical data. Last, the product of the uniqueness of the variable position and the length of the historical sample i.e., var_pos_uniqueᵢⱼ*total_values_variableᵢⱼ, must be less than a certain threshold δ. This condition ensures that the variable position is not composed of random strings. The threshold may be based on initial experimentation on log messages. The threshold may contribute to controlling the false positive rate in string anomalies, especially for newly added log templates.

In step 325, the anomaly detection computer program may add a new template based on the identified anomalies. A new template may be added when it is not found in the existing template dictionary. This may occur, for example, in the following scenarios: when a new network device is added in the network infrastructure; when a new functionality is enabled on an existing network device; or when standard logging formats are changed on new versions of existing device. When such a scenario occurs, a new log template may be added to the template dictionary, and statistics may be captured over time to accurately run anomaly detection.

The anomaly detection computer program may update dictionaries and data frames to accommodate new templates.

In step 330, the anomaly detection computer program may take a self-healing action based on the anomaly. For example, if the root cause indicates an attack, outside network connections may be disabled. If the root cause indicates a hardware issue, additional hardware may be deployed.

In one embodiment, the anomaly model may detect load balancing virtual server or pool objects in a flapping condition, and may issue a workflow to disable the object and mitigate the impact.

Other self-healing actions may be taken as is necessary and/or desired.

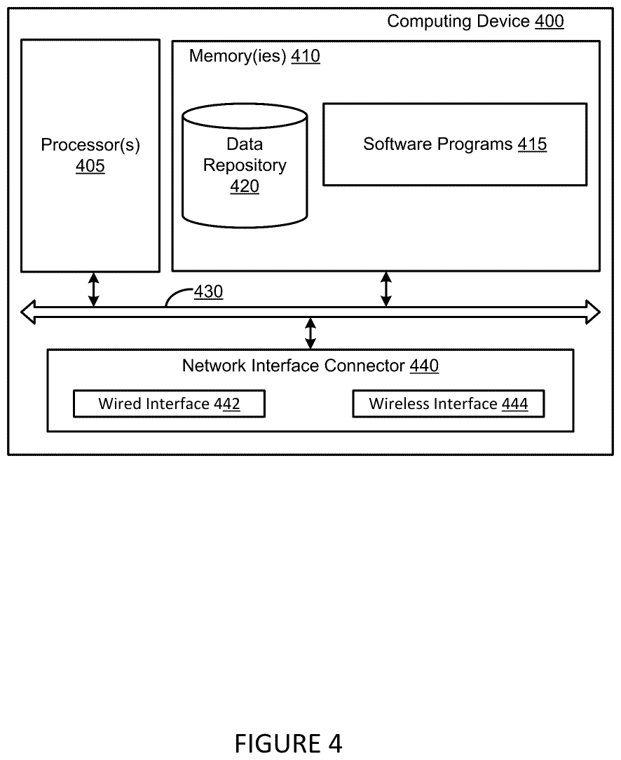

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Additional details may be found in the included Appendix, the disclosure of which is hereby incorporated, by reference, its entirety.

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method, comprising:
receiving, by an anomaly detection computer program, a plurality of log messages from a data source;
creating, by the anomaly detection computer program, an offline anomaly detection model by:
performing statistical modelling on the log messages from each network device;
creating a log template for each log message based on static and variables parts of the log message;
creating a template dictionary of log templates for each network device;
creating a log template distribution; and
creating template variables;
receiving, by the anomaly detection computer program, streaming data comprising log files from a plurality of network devices;
aggregating, by the anomaly detection computer program, the streaming data for each network device for a period of time;
identifying, by the anomaly detection computer program, an anomaly in the aggregated streaming data using the offline anomaly detection model;
classifying, by the anomaly detection computer program, the anomaly as a rate anomaly, a time anomaly, or a variable anomaly; and
executing, by the anomaly detection computer program, a self-healing action based on the classification.

2. The method of claim 1, wherein each log message comprises a date time of the log, a network device name or identifier, an error code, and an error description.

3. The method of claim 1, further comprising:
preprocessing, by the anomaly detection computer program, the log messages; and
encoding, by the anomaly detection computer program, the preprocessed log messages.

4. The method of claim 3, wherein the preprocessing comprises transforming the log messages.

5. The method of claim 1, wherein the statistical modelling comprises a rate and a distribution of each log message.

6. The method of claim 1, wherein the log template distribution is based on statistical rates and probabilities of the log templates for a period of time.

7. The method of claim 1, wherein the template variables comprise special identifiers for dynamic parts of the log messages.

8. The method of claim 1, further comprising:
calculating, by the anomaly detection computer program, a uniqueness of each variable position for each template variable in each log template.

9. The method of claim 1, wherein the rate anomaly is identified based on a rate of logs files in the aggregated streaming data for one of the log templates.

10. The method of claim 1, wherein the time anomaly is identified based on an average time between log files in the aggregated streaming data.

11. The method of claim 1, wherein the self-healing action comprises disabling outside network connections.

12. The method of claim 1, wherein the self-healing action comprises deploying additional hardware.

13. The method of claim 1, wherein the self-healing action comprises disabling a workflow.

14. A non-transitory computer readable storage medium, including instructions stored thereon, which when read and executed by one or more computer processors, cause the one or more computer processors to perform steps comprising:
receiving a plurality of log messages from a data source;
creating an offline anomaly detection model by:
performing statistical modelling on the log messages from each network device, wherein the statistical modelling comprises a rate and a distribution of each log message;
creating a log template for each log message based on static and variables parts of the log message;
creating a template dictionary of log templates for each network device;
creating a log template distribution, wherein the log template distribution is based on statistical rates and probabilities of the log templates for a period of time; and
creating template variables, wherein the template variables comprise special identifiers for dynamic parts of the log messages;
receiving streaming data comprising log files from a plurality of network devices;
aggregating the streaming data for each network device for a period of time;
identifying an anomaly in the aggregated streaming data using the offline anomaly detection model;
classifying the anomaly as a rate anomaly, a time anomaly, or a variable anomaly; and
executing a self-healing action based on the classification.

15. The non-transitory computer readable storage medium of claim 14, wherein each log message comprises a date time of the log, a network device name or identifier, an error code, and an error description.

16. The non-transitory computer readable storage medium of claim 14, further including instructions stored thereon, which when read and executed by the one or more computer processors, cause the one or more computer processors to perform steps comprising:
transforming the log messages; and
encoding the transformed log messages.

17. The non-transitory computer readable storage medium of claim 14, further including instructions stored thereon, which when read and executed by the one or more computer processors, cause the one or more computer processors to perform steps comprising:
calculating a uniqueness of each variable position for each template variable in each log template.

18. The non-transitory computer readable storage medium of claim 14, wherein the rate anomaly is identified based on a rate of logs files in the aggregated streaming data for one of the log templates and the time anomaly is identified based on an average time between log files in the aggregated streaming data.

19. The non-transitory computer readable storage medium of claim 14, wherein the self-healing action comprises disabling outside network connections, deploying additional hardware, and/or disabling a workflow.
